(19) United States
(12) Patent Application Publication
(10) Pub. No.: US 2020/0189215 A1
(43) Pub. Date: Jun. 18, 2020

(54) METHOD FOR FORMING A SEALANT LAYER IN A TIRE

(71) Applicant: The Goodyear Tire & Rubber Company, Akron, OH (US)

(72) Inventors: Jean-Claude Patrice Philippe Griffoin, Mertzig (LU); Kevin Erik M Pierret, Bastogne (BE); Nicolas Jovanic, Thionville (FR)

(21) Appl. No.: 16/413,007

(22) Filed: May 15, 2019

Related U.S. Application Data
(60) Provisional application No. 62/778,948, filed on Dec. 13, 2018.

(51) Int. Cl. B29C 73/16; B60C 19/12

(52) U.S. Cl. CPC B29C 73/163; B29D 2030/0697; B29C 73/166; B60C 19/122

(57) ABSTRACT

A method for forming a sealant layer in a tire is described, wherein the tire produced is balanced. The method comprising the steps of: providing a tire; and spraying a sealant layer on the inside of the tire, under the crown, wherein the sealant layer is sprayed at a zero degree angle with respect to the tire mid-circumferential plane as the tire is rotated.

### FIELD OF THE INVENTION

The invention relates in general to tire manufacturing, and more particularly to a method for forming a tire with post cure sealant.

### BACKGROUND OF THE INVENTION

Pneumatic tires with puncture sealant or tire constructions with puncture sealing properties are known to those skilled in the tire art. Typically, such tires include a layer of sealant typically sprayed on the inside of the tire. The sealant layer typically represents a significant mass added to the tire at the most critical diameter as far as tire imbalance is concerned. Prior art lay-ups of the sealant often result in an asymmetrical pattern with respect to the tire centerplane, and can result in a tire dynamic imbalance. Thus, it is desired to have an improved method and apparatus for forming a tire with a sealant layer that has no dynamic imbalance.

### Definitions

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

### BRIEF DESCRIPTION OF THE DRAWINGS

The invention will be described by way of example and with reference to the accompanying drawings in which:

FIG. 1 is a front view of a schematic of a tire sealant spray apparatus and tire.

FIG. 2 is a close-up view of the tire and nozzle of the tire sealant spray apparatus.

FIG. 3 illustrates a spirally wound sealant layup using the tire sealant spray apparatus.

FIG. 4A illustrates a close-up view of the spirally wound sealant layup, while

FIG. 4B illustrates the balanced spirally wound sealant layup;

FIG. 5 illustrates a sealant layup of the present invention using the tire sealant spray apparatus.

FIG. 6 illustrates a close-up view of the sealant layup of the present invention.

### DETAILED DESCRIPTION OF THE INVENTION

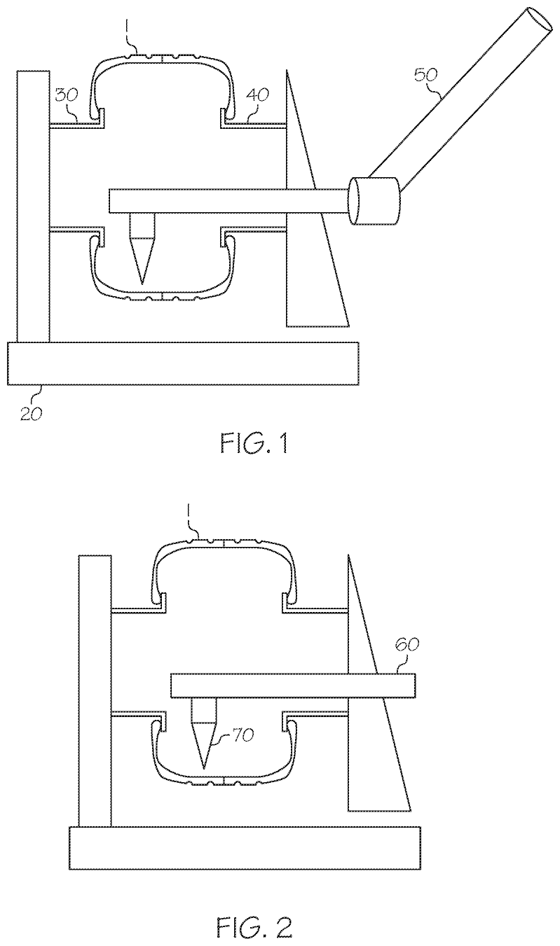

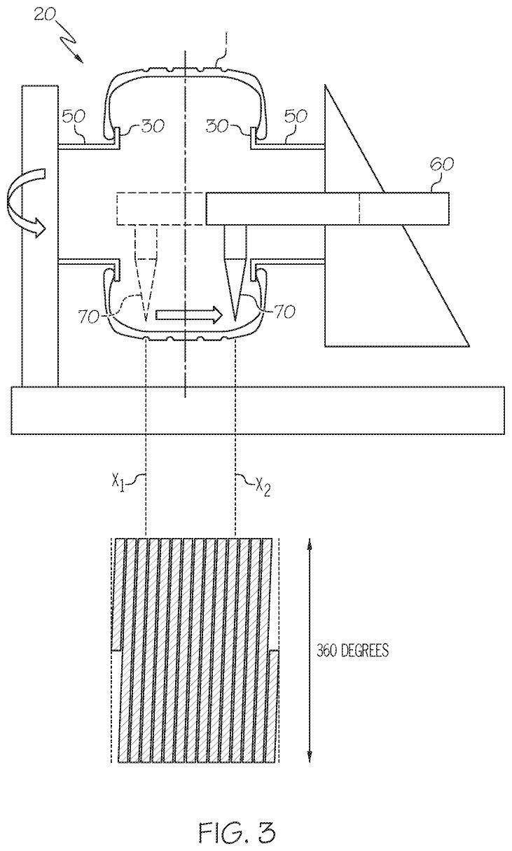

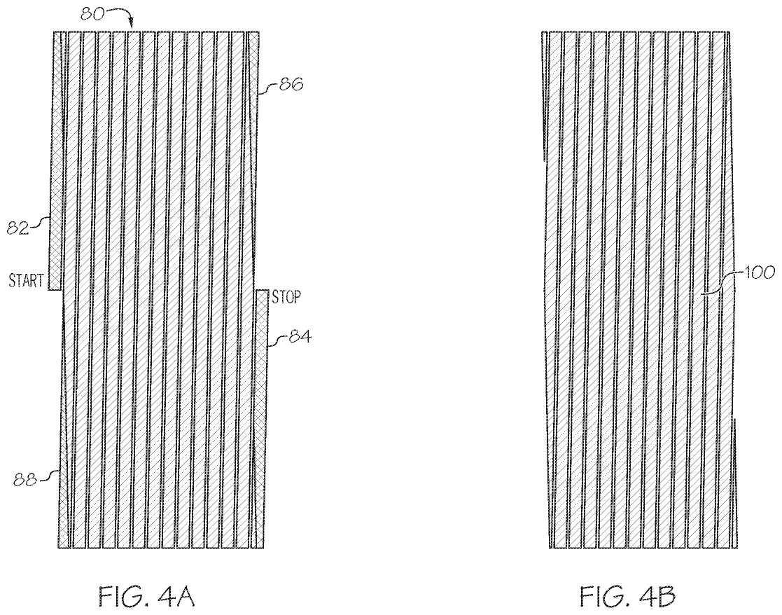

FIGS. 1 and 2 illustrate a tire T rotatably mounted in a sealant dispensing stand 20. The sealant dispensing stand 20 has tire grippers 30 for holding the tire and tire spreaders 40 for enlarging the tire width. The sealant dispensing stand 20 further includes a robot arm 50 having an application bar 60. The application bar 60 has a sealant dispensing nozzle 70. The robot arm 50 can move the application bar 60 in the axial direction of the tire to dispense a layer of sealant. FIG. 3 illustrates the dispensing nozzle applying a layer of sealant in a spirally wound configuration 80 as the dispensing nozzle translates in a direction parallel to the axis of rotation of the tire. A close-up view of the spirally wound configuration is shown in FIG. 4A. The spirally wound configuration 80 is spirally wound at a slight angle, typically in the range of 3-6 degrees (as measured from tire equatorial plane). The end portions 82,84,86,88, shown as cross-hatched shading, result in the tire imbalance. FIG. 4B illustrates a spirally wound configuration 100 with the end portions 82,84,86,88 removed, resulting in a balanced sealant configuration.

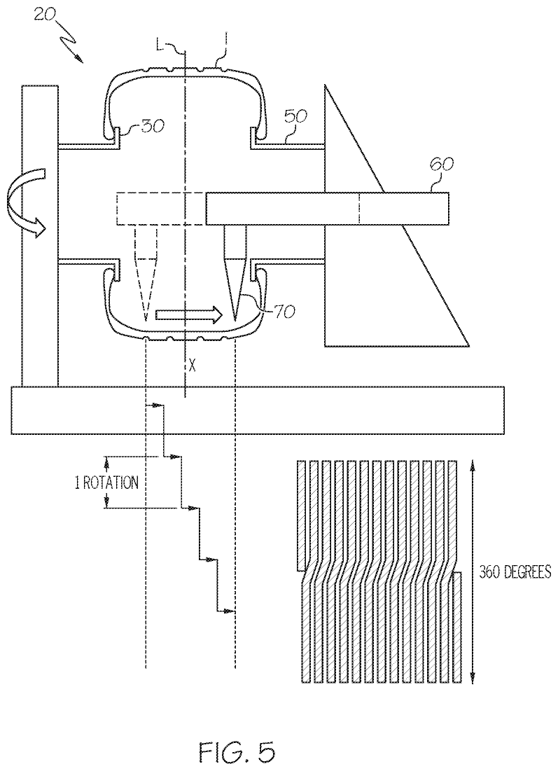

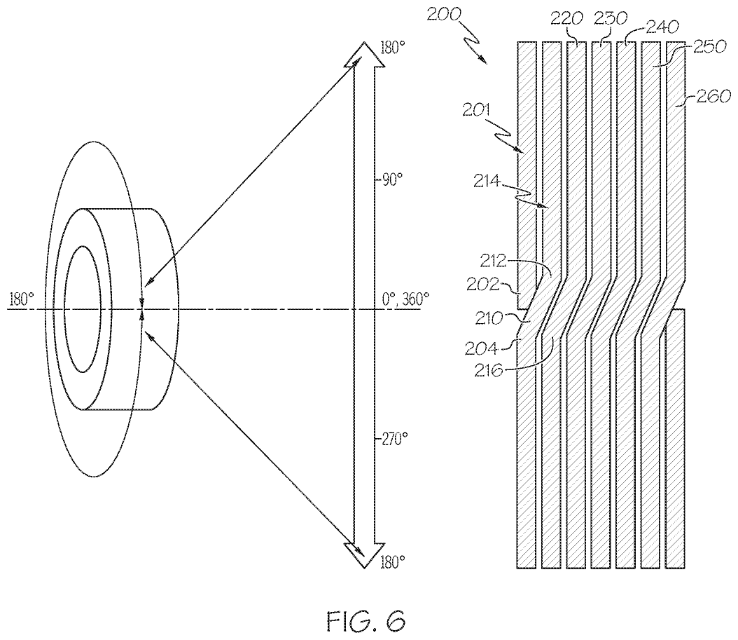

FIGS. 5-6 illustrate a second embodiment of the invention of a tire with a balanced sealant layer. The sealant layer configuration 200 is shown in FIG. 6. The sealant layer 200 is formed of multiple windings of a continuous strip of sealant. The sealant layer 200 has a first winding 201 having a starting portion 200 and an ending portion 204, wherein the sealant is applied in a strip between the start and end at a zero degree orientation or “straight.” The sealant spray orientation is at zero degrees with respect to the tire midcircumferential plane L. The first winding 201 remains oriented at zero degrees until approximately in the range of 320-358 degrees of tire rotation (i.e., less than 360 degrees of rotation), wherein the end 204 of the first sealant winding is angled in a transition section 210. The end of the transition portion 212 or the start of the second winding 214 is axially spaced apart from the start 202 of the first winding 201. The sealant layer is formed of multiple windings 201, 214, 220, 230, 240, 250, 260 that are oriented at zero degrees with respect to the tire midcircumferential plane and form a straight portion. Each straight portion of each winding is wound from 0 degrees to less than 360 degrees, and has an ending 204 connected to an optional transition section. The transition section is angled.

Variations in the present inventions are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method for forming a sealant layer in a tire, the method comprising the steps of:
providing a tire; and
applying one or more windings to form a sealant layer to the inside of the tire under the crown, wherein each winding has a straight portion aligned at a zero degree angle with respect to the tire mid-circumferential plane.

2. The method of claim 1 wherein the sealant is sprayed in a continuous manner.

3. The method of claim 1 wherein each winding is joined together by an angled transition section.

4. The method of claim 1 wherein a portion of the outer edges of the sealant layer are removed to form a balanced tire.

5. A method for forming a sealant layer in a tire, the method comprising the steps of:
providing a tire; and
applying a sealant layer on the inside of the tire underneath the crown, wherein the sealant layer is sprayed in a spirally wound manner, wherein a portion of the outer edges of the sealant layer are removed to form a balanced tire.

6. A tire having a tread, opposed sidewalls and an inner surface opposite the tread, wherein said inner surface has a sealant layer formed by spirally applying a plurality of sealant windings, wherein each winding has a straight portion.

7. The tire of claim 6 wherein a portion of the outer edges of the sealant layer are removed to form a balanced tire.

8. The tire of claim 6 wherein each winding is joined with a angled transition section.
